(19) United States
(12) Patent Application Publication
(10) Pub. No.: US 2025/0323385 A1
(43) Pub. Date: Oct. 16, 2025

(54) ELECTRICITY STORAGE CELL

(71) Applicant: TOYOTA JIDOSHA KABUSHIKI KAISHA, Toyota-shi (JP)

(72) Inventors: Masato Ono, Nagoya-shi (JP); Masahiro Ishizuka, Toyota-shi (JP); Atsushi Sugihara, Toyota-shi, (JP); Yuka Yokoi, Nagoya-shi (JP); Tatsuya Yamamoto, Toyohashi-shi (JP); Keitaro Machida, Hamamatsu-shi (JP); Ryosuke Sato, Toyota-shi, (JP)

(73) Assignee: TOYOTA JIDOSHA KABUSHIKI KAISHA, Toyota-shi (JP)

(21) Appl. No.: 19/090,625

(22) Filed: Mar. 26, 2025

(30) Foreign Application Priority Data
Apr. 12, 2024 (JP) 2024-064694

(51) Int. Cl. H01M 50/477; H01M 50/103; H01M 50/46

(52) U.S. Cl. CPC H01M 50/477; H01M 50/103; H01M 50/46

(57) ABSTRACT

An electricity storage cell includes a pair of cell units connected to each other, a cell case that houses the cell units, and a position defining portion that defines positions of the cell units relative to the cell case, the position defining portion being provided inside the cell case. The position defining portion includes an intermediate projection projecting from the cell case toward a position between the cell units.

### CROSS-REFERENCE TO RELATED APPLICATION

This application claims priority to Japanese Patent Application No. 2024-064694 filed on Apr. 12, 2024, incorporated herein by reference in its entirety.

### BACKGROUND

### 1. Technical Field

The present disclosure relates to an electricity storage cell.

### 2. Description of Related Art

For example, Japanese Unexamined Patent Application Publication (Translation of PCT application) No. 2023-509216 (JP 2023-509216 A) discloses a battery including a plurality of electrode element sets, and a case that houses the electrode element sets. The electrode element sets are connected one another in series by a first connecting member.

### SUMMARY

In the battery disclosed in JP 2023-509216 A, the electrode element set may be displaced relative to the case due to vibrations or other causes.

It is an object of the present disclosure to provide an electricity storage cell that can restrain displacement of a cell unit relative to a cell case.

An electricity storage cell according to an aspect of the present disclosure includes a pair of cell units, a cell case, and a position defining portion. The cell units are connected to each other. The cell case houses the cell units. The position defining portion is provided inside the cell case and defines positions of the cell units relative to the cell case. The position defining portion includes an intermediate projection projecting from the cell case toward a position between the cell units.

With the present disclosure, it is possible to provide an electricity storage cell that can restrain displacement of a cell unit relative to a cell case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view schematically showing an electricity storage cell in an embodiment of the present disclosure;

FIG. 2 is an exploded perspective view of the electricity storage cell shown in FIG. 1;

FIG. 3 is a sectional view taken along line III-III in FIG. 1;

FIG. 4 is a sectional view schematically showing a modification of a position defining portion; and

FIG. 5 is a sectional view schematically showing a modification of the position defining portion.

### DETAILED DESCRIPTION OF EMBODIMENTS

An embodiment of the present disclosure will be described with reference to the drawings. Note that, in the drawings referred to below, identical or equivalent members are designated by the same reference signs.

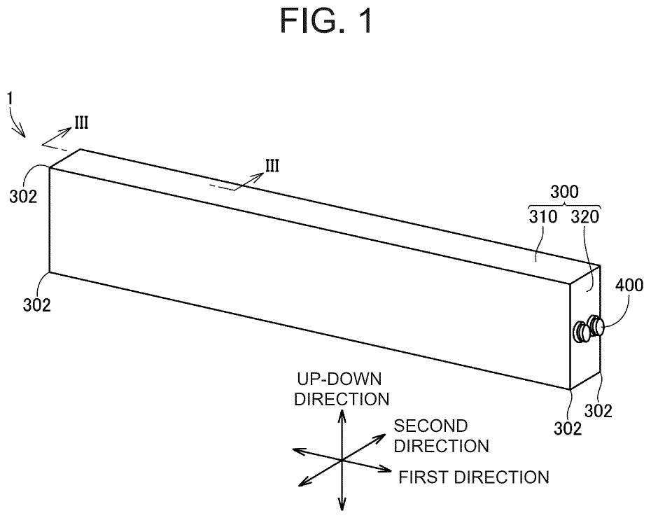

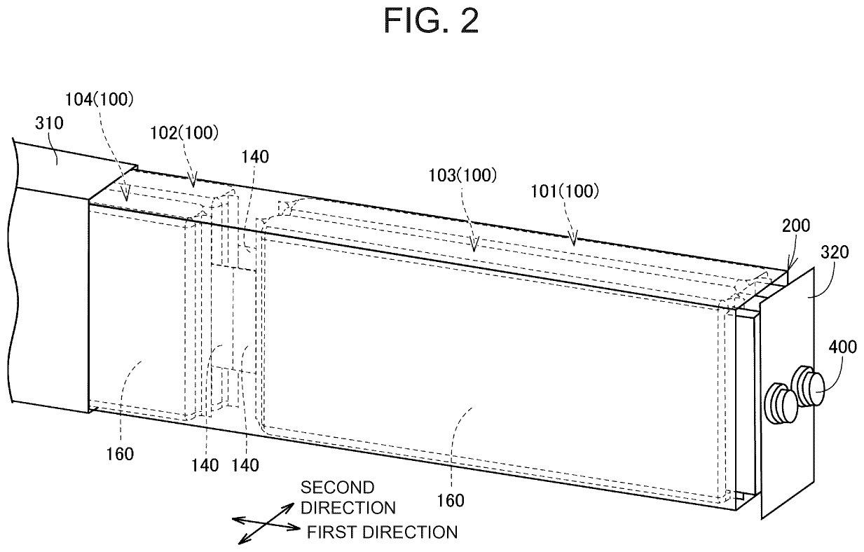

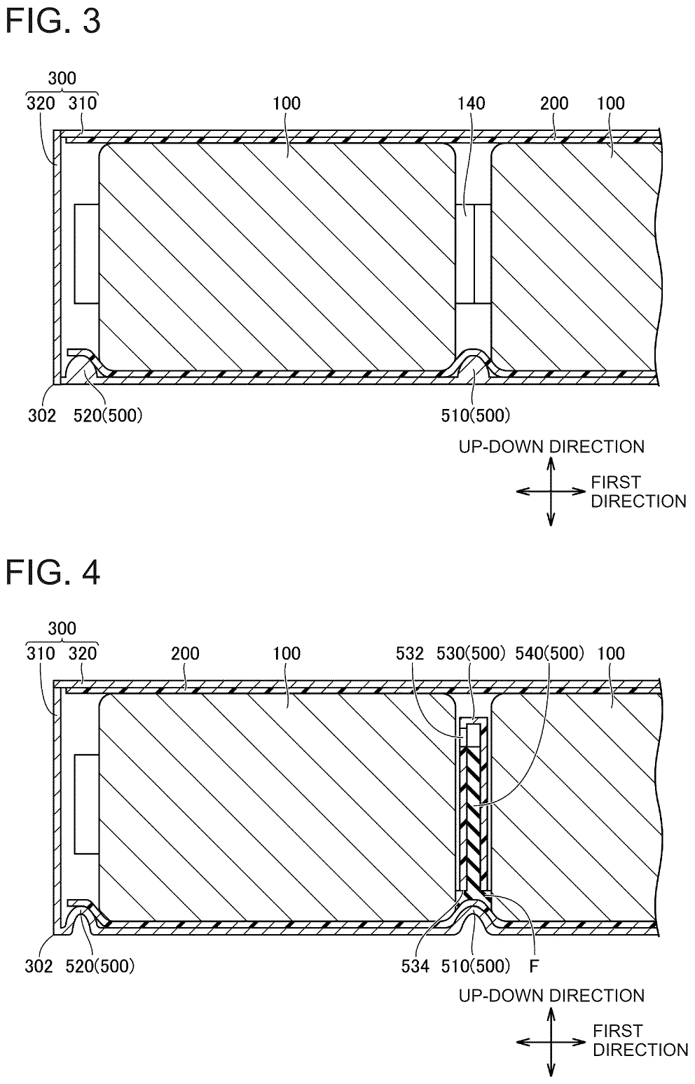

FIG. 1 is a perspective view schematically showing an electricity storage cell in an embodiment of the present disclosure. FIG. 2 is an exploded perspective view of the electricity storage cell shown in FIG. 1. FIG. 3 is a sectional view taken along line III-III in FIG. 1. The electricity storage cell 1 is, for example, mounted on a bottom portion of a vehicle.

As shown in FIGS. 1 to 3, the electricity storage cell 1 includes a plurality of cell units 100, a covering sheet 200, a cell case 300, an external terminal 400, and a position defining portion 500 (refer to FIG. 3).

As shown in FIG. 2, the cell units 100 include a first cell unit 101, a second cell unit 102, a third cell unit 103, and a fourth cell unit 104. In the present embodiment, the cell units 100 include eight cell units 100. However, the number of cell units 100 is not limited to eight. Each cell unit 100 is, for example, a lithium ion battery. Each cell unit 100 may be an all-solid-state battery containing a solid electrolyte.

The first cell unit 101 is connected to the second cell unit 102. The third cell unit 103 is connected to the fourth cell unit 104. That is, the first cell unit 101 and the second cell unit 102 are an example of “a pair of cell units connected to each other” in the present disclosure. Similarly, the third cell unit 103 and the fourth cell unit 104 are an example of “a pair of cell units connected to each other” in the present disclosure.

The first cell unit 101 and the third cell unit 103 are adjacent to each other in a second direction that is perpendicular to both a first direction in which the first cell unit 101 and the second cell unit 102 are arranged side by side and an up-down direction. The second cell unit 102 and the fourth cell unit 104 are adjacent to each other in the second direction. Each cell unit 100 has a shape that extends longer in the first direction than in the second direction and longer in the first direction than in the up-down direction. Each cell unit 100 has a shape that extends longer in the up-down direction than in the second direction.

Each cell unit 100 includes an electrode element (not shown), a current collector terminal 140, and a laminate exterior body 160.

The electrode element is a wound element including a positive electrode sheet and a negative electrode sheet that are wound with a separator interposed therebetween. However, the electrode element may be a stack including a positive electrode sheet and a negative electrode sheet that are stacked with a separator interposed therebetween. The electrode element has a shape that is long in a perpendicular direction perpendicular to both a stacking direction and the up-down direction.

The current collector terminal 140 is connected to the electrode element. The current collector terminal 140 projects in the first direction from the electrode element. The current collector terminal 140 electrically connected to the positive electrode sheet in the electrode element is made of, for example, aluminum. The current collector terminal 140 electrically connected to the negative electrode sheet in the electrode element is made of, for example, copper. The current collector terminal 140 has a flat plate shape.

As shown in FIG. 2, the current collector terminal 140 in the first cell unit 101 is connected to the current collector terminal 140 in the second cell unit 102. Similarly, the current collector terminal 140 in the third cell unit 103 is connected to the current collector terminal 140 in the fourth cell unit 104.

The laminate exterior body 160 houses the electrode element, and a part of the current collector terminal 140. The laminate exterior body 160 is a laminate film. The current collector terminal 140 projects outward in the first direction from an edge portion of the laminate exterior body 160.

The covering sheet 200 covers the cell units 100. More specifically, the covering sheet 200 covers the cell units 100 such that the covering sheet 200 collectively surrounds the cell units 100. The covering sheet 200 is made of an insulating material (e.g., a synthetic resin). Note that the covering sheet 200 may be omitted.

The cell case 300 houses the cell units 100 and the covering sheet 200. The cell case 300 is made of, for example, aluminum. The cell case 300 has a rectangular parallelepiped shape that is long in the first direction. The cell case 300 has eight vertex portions 302 (refer to FIG. 1). As shown in FIGS. 1 to 3, the cell case 300 has a case body 310, and a lid 320.

The case body 310 has a rectangular tubular shape that is long in the first direction. The case body 310 surrounds the cell units 100 and the covering sheet 200.

The lid 320 is connected to the case body 310 by, for example, welding to close an opening of the case body 310. Note that, the case body 310 may have a shape open upward. In this case, for example, after the cell units 100 are inserted into the case body 310 from above, the lid 320 is connected to the top of the case body 310.

The external terminals 400 are provided on the lid 320. The external terminals 400 are connected one-to-one to the current collector terminals 140 of the first cell unit 101 and the third cell unit 103 that are disposed closest to the lid 320 among the cell units 100.

The position defining portion 500 defines the position of the pair of cell units relative to the cell case 300. In the present embodiment, the position defining portion 500 defines the positions of the first cell unit 101 and the second cell unit 102 and also defines the positions of the third cell unit 103 and the fourth cell unit 104. The position defining portion 500 is provided inside the cell case 300. As shown in FIG. 3, the position defining portion 500 has an intermediate projection 510, and a corner projection 520.

The intermediate projection 510 projects from the cell case 300 toward a position between the pair of cell units. More specifically, the intermediate projection 510 projects from an inner face of the case body 310 toward the current collector terminals 140 in the pair of cell units. In the present embodiment, the intermediate projection 510 projects from a bottom face of the cell case 300. However, the intermediate projection 510 may project from a side face of the case body 310 (the face of the case body 310 facing the current collector terminals 140 in the second direction) toward the current collector terminals 140 or may project from a top face of the case body 310 toward the current collector terminals 140.

The intermediate projection 510 is in contact with a corner portion of each cell unit 100. More specifically, the intermediate projection 510 is in contact with a corner portion of the laminate exterior body 160 through the covering sheet 200.

The intermediate projection 510 is made of the same material as the case body 310 and integrally formed with the case body 310. However, the intermediate projection 510 may be configured as a separate body from the case body 310 and connected to the inner face of the case body 310. Alternatively, the intermediate projection 510 may be formed by pressing a part of the case body 310.

The corner projection 520 is provided at the vertex portion 302 of the cell case 300. The corner projection 520 projects from the bottom face of the case body 310. However, the corner projection 520 may be provided on the side face of the case body 310, may be provided on the top face of the case body 310, or may be provided on an inner face of the lid 320.

The corner projection 520 is in contact with a corner portion of the cell unit 100. More specifically, the corner projection 520 is in contact with a corner portion of the laminate exterior body 160 through the covering sheet 200.

The corner projection 520 is made of the same material as the case body 310 and integrally formed with the case body 310. However, the corner projection 520 may be configured as a separate body from the case body 310 and connected to the inner face of the case body 310 or may be configured as a separate body from the lid 320 and connected to the inner face of the lid 320. Alternatively, the corner projection 520 may be formed by pressing a part of the case body 310 or a part of the lid 320.

As described above, in the electricity storage cell 1 in the present embodiment, since the cell case 300 is provided with the intermediate projection 510, displacement of each cell unit 100 relative to the cell case 300 is effectively restrained.

Furthermore, since the corner projection 520 is in contact with the cell unit 100, the displacement of each cell unit 100 relative to the cell case 300 is more effectively restrained.

Hereinbelow, modifications of the above embodiment will be described.

### First Modification

As shown in FIG. 4, the position defining portion 500 may further include an intermediate member 530, and an adhesive member 540.

The intermediate member 530 is disposed between the pair of cell units. The intermediate member 530 is disposed over the intermediate projection 510. In the present modification, the intermediate member 530 is disposed between a junction between the current collector terminal 140 of the first cell unit 101 and the current collector terminal 140 of the second cell unit 102 and a junction between the current collector terminal 140 of the third cell unit 103 and the current collector terminal 140 of the fourth cell unit 104.

The intermediate member 530 has a hollow shape. The intermediate member 530 may have a rectangular tubular shape. The intermediate member 530 has an upper opening 532 formed in an upper portion of the intermediate member 530, and a lower opening 534 open downward. The lower opening 534 provides an outflow path F for the adhesive member 540 between the lower opening 534 and the intermediate projection 510. In the example shown in FIG. 4, the intermediate projection 510 is formed by pressing a part of the case body 310.

The adhesive member 540 is filled inside the intermediate member 530. The adhesive member 540 filled into the intermediate member 530 through the upper opening 532 flows out of the intermediate member 530 through the outflow path F. The adhesive member 540 bonds the laminate exterior body 160 of each cell unit 100 and the intermediate projection 510 to each other. In the example shown in FIG. 4, the adhesive member 540 bonds the laminate exterior body 160 of each cell unit 100 and the intermediate projection 510 to each other through the covering sheet 200.

In the example shown in FIG. 4, the case body 310 has a shape open upward. The lid 320 is connected to the top of the case body 310. In this example, the cell units 100 are inserted into the case body 310 from above the case body 310.

### Second Modification

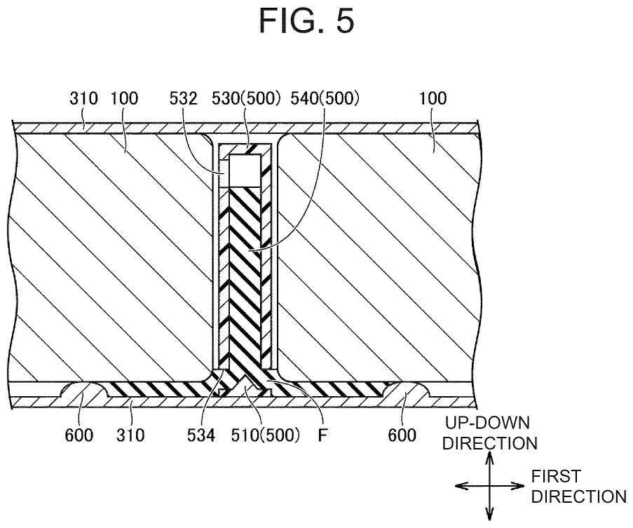

As shown in FIG. 5, the electricity storage cell 1 may further include a pair of weirs 600. The weirs 600 are provided on the bottom face of the case body 310. The weirs 600 restrict the adhesive member 540 from spreading in the first direction. The weirs 600 are provided with the intermediate projection 510 interposed therebetween in the first direction. One of the weirs 600 is provided under one of the cell units 100 adjacent to each other in the first direction, and the other one of the weirs 600 is provided under the other one of the cell units 100 adjacent to each other in the first direction. Each cell unit 100 is in contact with the upper face of the corresponding weir 600.

Each weir 600 is made of the same material as the case body 310 and integrally formed with the case body 310. However, each weir 600 may be configured as a separate body from the case body 310 and connected to the bottom face of the case body 310. Alternatively, each weir 600 may be formed by pressing a part of the bottom face of the case body 310.

In the example shown in FIG. 5, the intermediate projection 510 and the intermediate member 530 are made of the same material (e.g., a synthetic resin) as each other and integrally formed with each other.

It is understood by those skilled in the art that the exemplary embodiment and modifications described above are specific examples of the following aspects.

### First Aspect

An electricity storage cell including:
a pair of cell units connected to each other;
a cell case that houses the cell units; and
a position defining portion that defines positions of the cell units relative to the cell case, the position defining portion being provided inside the cell case, in which
the position defining portion includes an intermediate projection projecting from the cell case toward a position between the cell units.

In the electricity storage cell, since the cell case is provided with the intermediate projection, displacement of each cell unit relative to the cell case is effectively restrained.

### Second Aspect

The electricity storage cell according to the first aspect, in which:
the cell case has a rectangular parallelepiped shape; and
the intermediate projection projects from a bottom face of the cell case.

### Third Aspect

The electricity storage cell according to the first or second aspect, in which the intermediate projection is in contact with a corner portion of each of the cell units.

In the third aspect, the displacement of each cell unit relative to the cell case is more reliably restrained.

### Fourth Aspect

The electricity storage cell according to any one of the first to third aspects, in which:
the cell case has a rectangular parallelepiped shape; and
the position defining portion includes a corner projection provided at a vertex portion of the cell case, the position defining portion being in contact with a corner portion of a corresponding one of the cell units.

In the fourth aspect, the displacement of each cell unit relative to the cell case is even more reliably restrained.

### Fifth Aspect

The electricity storage cell according to any one of the first to fourth aspects, in which:
the position defining portion further includes
   an intermediate member having a hollow shape, the intermediate member being disposed between the cell units, and
   an adhesive member filled inside the intermediate member;
the intermediate member has
   an upper opening provided in an upper portion of the intermediate member, and
   a lower opening open downward; and
the lower opening provides an outflow path for the adhesive member between the lower opening and the intermediate projection.

In the fifth aspect, since the adhesive member filled into the intermediate member through the upper opening flows out of the intermediate member through the outflow path provided between the lower opening and the intermediate projection and comes into contact with the cell units, the intermediate member has both the function of positioning the cell units and the function of forming a channel for the adhesive member.

Note that, the embodiment disclosed herein should be considered in all respects illustrative and not restrictive. The scope of the present disclosure is defined by the claims rather than the foregoing description of the embodiment, and includes all changes that fall within the meaning and scope equivalent to the claims.

What is claimed is:

1. An electricity storage cell comprising:
a pair of cell units connected to each other;
a cell case that houses the cell units; and
a position defining portion that defines positions of the cell units relative to the cell case, the position defining portion being provided inside the cell case, wherein
the position defining portion includes an intermediate projection projecting from the cell case toward a position between the cell units.

2. The electricity storage cell according to claim 1, wherein:
the cell case has a rectangular parallelepiped shape; and
the intermediate projection projects from a bottom face of the cell case.

3. The electricity storage cell according to claim 1, wherein the intermediate projection is in contact with a corner portion of each of the cell units.

4. The electricity storage cell according to claim 1, wherein:
the cell case has a rectangular parallelepiped shape; and
the position defining portion includes a corner projection provided at a vertex portion of the cell case, the position defining portion being in contact with a corner portion of a corresponding one of the cell units.

5. The electricity storage cell according to claim 1, wherein:
the position defining portion further includes
an intermediate member having a hollow shape, the intermediate member being disposed between the cell units, and
an adhesive member filled inside the intermediate member;
the intermediate member has
an upper opening provided in an upper portion of the intermediate member, and
a lower opening open downward; and
the lower opening provides an outflow path for the adhesive member between the lower opening and the intermediate projection.
